(19) United States
(12) Patent Application Publication
(10) Pub. No.: US 2002/0146154 A1
(43) Pub. Date: Oct. 10, 2002

(54) Method and system for mitigating distortive effects in biometric samples in a biometric verification system

(76) Inventors: Dustin M. Davis, Round Rock, TX (US); Jane R. Garrison, Austin, TX (US)

Correspondence Address: John H. D' Antico, Brobeck, Phleger & Harrison LLP, 4801 Plaza on the Lake, Austin, TX, 78746, US

(21) Appl. No.: 09/828,477

(22) Filed: Apr. 5, 2001

(51) Int. Cl. G06K 9/00; G06K 9/62

(52) U.S. Cl. 382/115; 382/209

(57) ABSTRACT

The present invention comprises methods and systems for mitigating distortive effects in biometric samples in a biometric verification system. More specifically, it generates a live template from a live image, and stores the live template as a rolling template, if the live template corresponds to the master template according to predefined criteria. As a result, the system allows the applicant to subsequently access the system if a subsequent live template generated from a subsequent live image of the biometric sample for the applicant corresponds to either the master template or the rolling template according to predefined criteria. Thus, the inventive arrangements accommodate dynamic changes in an applicant's biometric samples.

### CROSS-REFERENCES TO RELATED APPLICATIONS

### STATEMENT REGARDING FEDERALLY SPONSORED RESEARCH OR DEVELOPMENT

### MICROFICHE APPENDIX

### BACKGROUND OF THE INVENTION

1. Field of the Invention

This invention relates generally to verification systems, and more specifically, to methods and systems for storing one or more rolling templates in a biometric verification system that stores one or more multiple master templates.

2. Description of Related Art

Nearly every transaction requires one or more reasonable assurances between transacting parties. For example, many governments require reasonable assurances of safety and know-how before permitting persons to legally drive on non-private roads; such reasonable assurances are commonly expressed by a driver's license. Many merchants require reasonable assurances of credit-worthiness before permitting persons to purchase goods and services on credit; such reasonable assurances are commonly evinced by a credit or debit card. Many businesses require reasonable assurances of identity before permitting persons to access various parts or areas of a building or structure, such as an office building, hotel, parking garage, etc., or part thereof; such reasonable assurance are commonly evinced by an access card. Many other businesses require reasonable assurances of identity before permitting persons to receive various entitlements; such reasonable assurances are commonly evinced by an entitlement card—such as a membership card, loyalty card, or other reward card, including frequently flyer and frequent buyer club cards. Many of these types of data cards are also used in other transactions requiring reasonable assurances of identity, such as at an election polling place, an immigration check-point, an airport, a time and attendance unit such as a time-clock or security patrol, and others. Many individuals are thus forced to carry many different data cards for many different types of transactions at many different times.

Driver's licenses, credit or debit cards, access cards, and entitlement cards are common examples of data cards. Not uncommonly, data cards encode personal data—such as a person's name, account number, and expiration date—in one or more bar codes, magnetic strips, or other recording media which are affixed thereto and carry binary or other coded data therein. Although conceivably available in a seemingly infinite variety of shapes and sizes, most data cards generally comprise flat, stiff, small, and rectangular pieces of material such as paper, paperboard, plastic, etc. They intend to confer a capability on an authorized user thereof. However, because data cards are not uniquely tied to authorized users, fraudulent possession thereof can often be used for fraudulent purposes. Thus, numerous entities have employed numerous techniques in attempting to decrease fraudulent data card activities, the costs of which are generally absorbed through higher prices and taxes.

For example, many data cards have master signature lines that must correspond to live signatures presented at points-of-sale at the time a financial transaction is consummated. However, non-authorized users can often forge the authorized user's signature with sufficient accuracy to fool a receiving agent's cursory inspection thereof. In addition, the presentation of a live signature on a data card slip or check slows the speed at which the transaction can be consummated. Many business would thus profit from being able to reduce the exchange of paperwork required to compare master and live signatures.

Many other data cards have a master photograph that is matched against the live person presenting the card at the time of the transaction. However, non-authorized users can use sophisticated photographic and other techniques to again fool the receiving agent's cursory inspection thereof. Similarly, data cards containing holograms, angularly reflective printing, or other super-imposed, low-contrasting printing techniques are not beyond reproach.

Authorization codes, such as a unique social security number or arbitrary personal number or personal code, whether used in conjunction with a data card or separately therefrom, are similarly plagued by nefarious problems. For instance, while such codes are, in theory, unique to the authorized user, the ability to present such codes is not. Thus, for example, not only are authorized users burdened with memorizing different authorization codes for different data cards and in different contexts, but any person presenting the authorization code is recognized as an authorized user, and non-authorized users have numerous surreptitious methods for obtaining such codes.

In any data card system, user convenience is of paramount importance. For example, it is highly desirable to permit spontaneous or impulse access to authorized users, particularly when unexpected needs arise. For example, if a particular data card is unavailable, even the authorized user's transaction may be thwarted. In addition, any person who has lost or otherwise misplaced a data card, left a data card at home, or had a data card stolen or otherwise misappropriated, knows well the inconveniences felt during the card's absence. In many instances, it is thus desirable to eliminate functional dependency on a specific data card to enable transactions by otherwise authorized users. Even a universal data card does not entirely eliminate this problem if possession thereof is still required for consummating a transaction therewith. Thus, it is desirable to allow data card transactional activity without requiring possession thereof. In other words, it is desirable to be able to be able to consummate a transaction without a specific data card, and to verify that a person in possession thereof is indeed an authorized user thereof. In addition, with less to carry, the less that can be misplaced or misappropriated.

As a result of shortcomings in the above-referenced fraud reduction techniques, non-authorized users may be able to use stolen or otherwise improperly obtained data cards and authorization codes as if the non-authorized user was in fact an authorized user. As long as verification systems are based solely on data is easily replicated and transferred—as opposed to data that is irreproducible and unique to an authorized user—such systems must rely, at least in part, on the authorized user's diligence and often luck in secreting some part of the data card. Recent increases in data card scams and automated teller machine (“ATM”) infractions, for example, testify to the vulnerability of such data card systems, as do complaints from authorized user's who unwisely or unknowingly tendered a data card to a less thrifty friend or family member. Thus, what is needed are methods and systems for allowing secure data card transactional activity, thereby eliminating or reducing fraud in connection therewith.

To be sure, financial industries lose billions of dollars in revenue each year due to fraudulent data card activity. As a result, various financial institutions have slowly begun implementing various biometric verification systems (i.e., systems that determine whether the person presenting the data card is an authorized user thereof based on one or more of the authorized user's unique biocharacteristics). Effective biocharacteristics must be easily and non-intrusively obtained, easily and cost-effectively stored and analyzed, and the use thereof must not unduly invade a person's privacy rights. Representative biocharacteristics include fingerprints, voiceprints, handprints, hand writing, hand geometries, facial geometries, facial recognition, retinal scans, iris scans, thermal imaging, and the like.

Biometric verification systems are ordinarily implemented by measuring or recording a referent biocharacteristic from an authorized user to be used for future comparisons. Then, in every subsequent access attempt, a sampled live biocharacteristic is compared against the referent master biocharacteristic in an attempt to verify the possessor's identity as an authorized user. Because the biocharacteristic is uniquely personal to the authorized user, and because the act of physically presenting the biocharacteristic is virtually irreproducible, biocharacteristic matches are putative of actual identity—as opposed to verifying identity by possession of freely-transferable data card or authorization code—and thereby reducing fraud, for example, by deterring a false affidavit claiming a data card was stolen or that its use was not otherwise authorized. What is needed, therefore, are improvements in the versatility of existing biometric verification systems.

Biometric samples are seldom static. Rather, they change due to the passage of time, seasons, weather, and other factors. For example, an applicant's fingerprint or voiceprint may change as they age, and their biometric characteristics accordingly change. Similarly, an applicant's biometric sample may not appear the same to a biometric scanner on a hot, summer day and a rainy, humid day. Physical illness can also effect the receipt of a voiceprint, for example. Physical activity can also introduce inaccuracies into the system; for example, perspiration and oils or the like may build up on a fingerprint due to physical exertion. Bums and chemical damage on a fingerprint can also effect the receipt of a biometric sample. Other problems can also occur, for example, when a warm fingerprint is placed against a cold platen, or vice versa, thereby fogging the platen and distorting the reflected image. What is needed, therefore, in order to eliminate or otherwise lessen erroneous results, are methods and systems accommodating the dynamic nature of biometric samples.

The foregoing and other objects, advantages, and aspects of the present invention will become apparent from the following description. In the description, reference is made to the accompanying drawings which form a part hereof, and in which there is shown, by way of illustration, a preferred embodiment of the present invention. Such embodiment does not represent the full spirit or scope of the invention, however, and reference must also be made to the claims herein for properly interpreting the spirit and scope of this invention.

Reference is also made to the following applications, filed herewith and hereby incorporated by reference: Method and System for Interacting with a Biometric Verification System, inventors Dustin M. Davis and Jane R. Garrison; Method And System for Consummating a Transaction in a Biometric Verification System Based on Prior Transactional Histories, inventors Dustin M. Davis and Jane R. Garrison; and Method and System for Migrating Dynamic Master Templates in a Biometric Verification System, inventors Garland R. Bullock and Paul V. Tischler.

### BRIEF SUMMARY OF THE INVENTION

This invention presents methods and systems for accommodating the dynamic nature of biometric samples. More specifically, the biometric verification system receives a live image of a biometric sample from an applicant; generates a live template from the live image; and stores the live template as a rolling template if the live template corresponds to the master template according to predefined criteria; wherein the system allows the applicant to access the system if a subsequent live template generated from a subsequent live image of the biometric sample for the applicant corresponds to either the master template or the rolling template according to predefined criteria. In one embodiment, the system stores the rolling template as a master template. In other embodiments, the system stores a predetermined number of rolling templates sorted according to predefined criteria.

The presented methods and systems are compatible with any system that stores a combination of robust identification data and multiple master templates for each biometric sample for the applicant. In addition, the inventive arrangements present a computer-readable storage medium comprising computer executable code for instructing a computer to execute the described methods.

### BRIEF DESCRIPTION OF THE SEVERAL VIEWS OF THE DRAWINGS

FIG. 1 is a representative hardware diagram depicting a simplified transactional environment in which preferred embodiments of the present invention may be practiced;

FIG. 2 is a representative flow chart depicting a preferred method by which an applicant enrolls in the present system;

FIG. 3 is a representative flow chart depicting a preferred method by which an applicant accesses the present system;

FIG. 4 is a representative flow chart depicting a preferred method by which an applicant adds applicant data to the present system;

FIG. 5 is a representative flow chart depicting a preferred method by which an applicant re-masters one or more master templates in the present system; and

FIG. 6 is a representative flow chart depicting a preferred method by which the present system mitigates distortive effects in biometric samples.

### DETAILED DESCRIPTION OF THE INVENTION

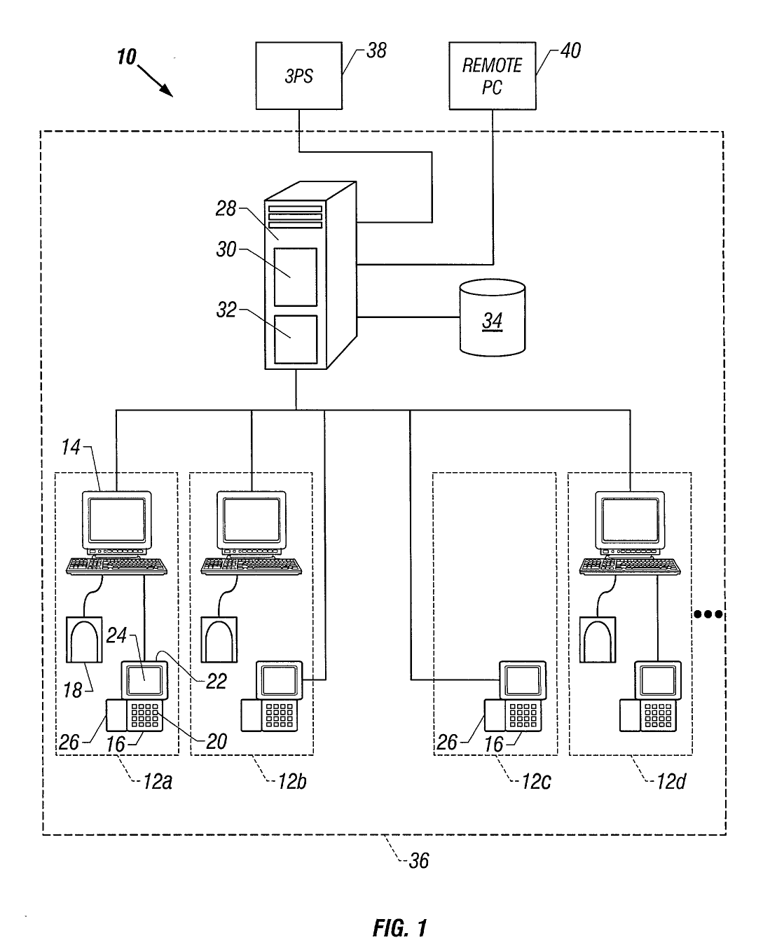

FIG. 1 is a representative hardware diagram depicting a simplified transactional environment 10 in which preferred embodiments of the present invention may be practiced. More specifically, the environment 10 comprises one or more points-of-sale 12a, 12b, 12c, 12d, . . . (collectively referred to as “12”) that are typically found in retail environments such as grocery stores, hardware stores, restaurants, and the like.

A first representative point-of-sale 12a comprises a control terminal 14, a biometric scanning device 16, and other periphery 18 such as a magnetic ink character reader (“MICR”). A representative control terminal 14 includes, for example, an IBM 4694 available from International Business Machines Corporation of Armonk, N.Y. A commercially available and representative biometric scanning device 16 preferably includes an alphanumeric data input device 20 such as a keypad or other input means; a binary or other coded data input device 22 that reads data from magnetic strips, bar codes, or other recording media commonly carried on data cards and other types of cards; a graphic and textual output device 24 such as a display screen; and a biometric scanner 26 configured to receive biometric samples such as fingerprint images, voiceprints, handprints, hand geometries, retinal scans, and the like. A representative biometric scanner 26 configured to receive fingerprint images, for example, comprises an optics module (not shown) having a transparent platen with opposing interior and exterior surfaces, whereby an applicant presses a finger against the exterior surface, a light source projects light from beneath the interior surface, and the light that is reflected from the interior surface according to the finger pressed against the exterior surface is modulated into a fingerprint image and captured on a receiving or processing apparatus such as screen, camera, array of photocells, or other. Common fingerprint imaging apparatuses include U.S. Pat. Nos. 4,537,484 to Fowler et. al; U.S. Pat. No. 4,544,267 to Schiller; and U.S. Pat. No. 5,230,025 to Fishbine et. al.

The biometric scanning device 16 and other periphery 18 connect to the control terminal 14 by well-known interfacing techniques for connecting serial devices, such as RS-485, RS-232, Universal Serial Bus (“USB”), and other standard interfaces. However, the present invention is not limited to any of these standard interfaces, nor to any other of the above-described arrangements. For example, the biometric scanning device 16 may not connect to the control terminal 14 in a second representative point-of-sale 12b, or a third representative point-of-sale 12c may comprise only the biometric scanning 16 device, which, in turn, may comprise a biometric scanner 26 other than the one described above. In addition, the alphanumeric data input device 20 and textual and graphic output device 24 may be combined into a single device using a light pen, mouse, pull-down menus, or other well-known techniques for data input and output.

Within the environment 10, a central server (“CS”) 28 preferably connects to the points-of-sale 12 to establish client-server relationships therewith. The CS 28 preferably connects to the points-of-sale 12 by the well-known Transmission Control Protocol “(TCP”) and Internet Protocol (“IP”), or if the second representative point-of-sale 12c comprises only the biometric scanning device 16, then by the TCP/IP, RS-485, short range radio, or other standard interfaces. A representative CS 28 includes, for example, a PENTIUM® class machine available from Dell Computer Corporation of Austin, Tex. Physically, the CS 28 is local to or remote from the points-of-sale 12.

As well understood in the art, the CS 28 preferably includes at least a central processing unit (“CPU”) 30, an internal memory device 32 such as a random access memory (“RAM”), and a fixed storage device 34 such as a hard-disk drive, which can also be physically local to or remote from the CS 28. The fixed storage device 34 preferably stores therein an operating system such as, for example, Windows NT or Windows 2000, available from Microsoft Corporation of Redmond, Washington, and various application programs, such as the biometric verification system of the present invention. As well understood in the art, the CPU 30 rapidly executes application programs loaded into the internal memory device 32.

The inventive arrangements can be realized in hardware, software, or a combination thereof. They may be carried out in a centralized fashion on one CS 28, in a distributed fashion whereby different functional elements are spread across multiple and interconnected CSs 28, or with one CS 28 for each of the points-of-sale 12, or otherwise. Any kind of CS 28, computer system, or other apparatus adapted for carrying out the methods described herein, is suited. A typical combination of hardware and software comprise a general purpose computer system with a computer program that, when loaded and executed, controls the computer system such that it carries out the methods described herein. The present invention can also be embedded in a computer program product that comprises the features enabling implementation of the methods described herein, and which, when loaded into a computer system as described, carries out the described methods.

Generalizing then, the described functionality is preferably implemented in software that is executed by the CS 28 as a set of instructions or program code contained in one or more application programs. Thus, a computer programmer of ordinary skill in the art may implement the inventive arrangements disclosed herein by employing well-known computer programming techniques and protocols without undue experimentation, and by utilizing this disclosure.

Referring again to the environment 10 of FIG. 1, the points-of-sale 12 and CS 28 are preferably part of a local area network (“LAN”) 36. In a preferred embodiment outside the LAN 36, the CS 28 also connects to third party servers 38, such as the Automated Clearing House (“ACH”) and others, and may be controlled, monitored, and otherwise accessed from a remote computer 40 through commercially available remote connection software. A representative remote computer 40 includes, for example, a PENTIUM® class machine available from Dell Computer Corporation of Austin, Tex.

Depending on context, an “applicant” generally refers, as used throughout this description, to a person enrolling or attempting to enroll in the biometric verification system, or to an enrolled person accessing or attempting to access the system. To effectuate transactional activities, the applicants generally interact with the system through the points-of-sale 12 or the remote computer 40. For example, the system receives enrollment data and identification data (elaborated upon below) through the control terminal 14, other periphery 18, the alphanumeric data input device 20, the binary or other coded data input device 22, and the remote computer 40, which are preferably menu-driven. The system receives images of biometric samples through the biometric scanner 26. Similarly, the system presents text, graphics, and the like on the textual and graphic output device 24 to communicate with the applicants. In a preferred embodiment, the text, graphics, and like are customized for a particular transactional environment 10, as understood in the art. In any event, the points-of-sale 12 provide primary means for the applicants to interact with the inventive arrangements.

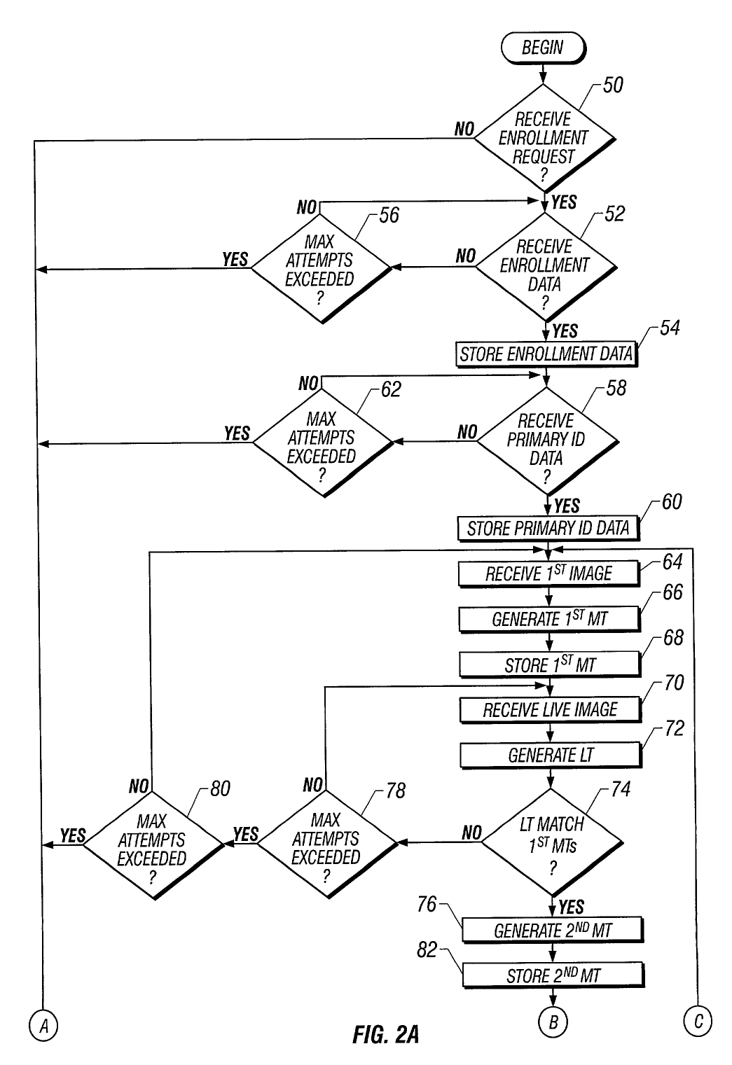

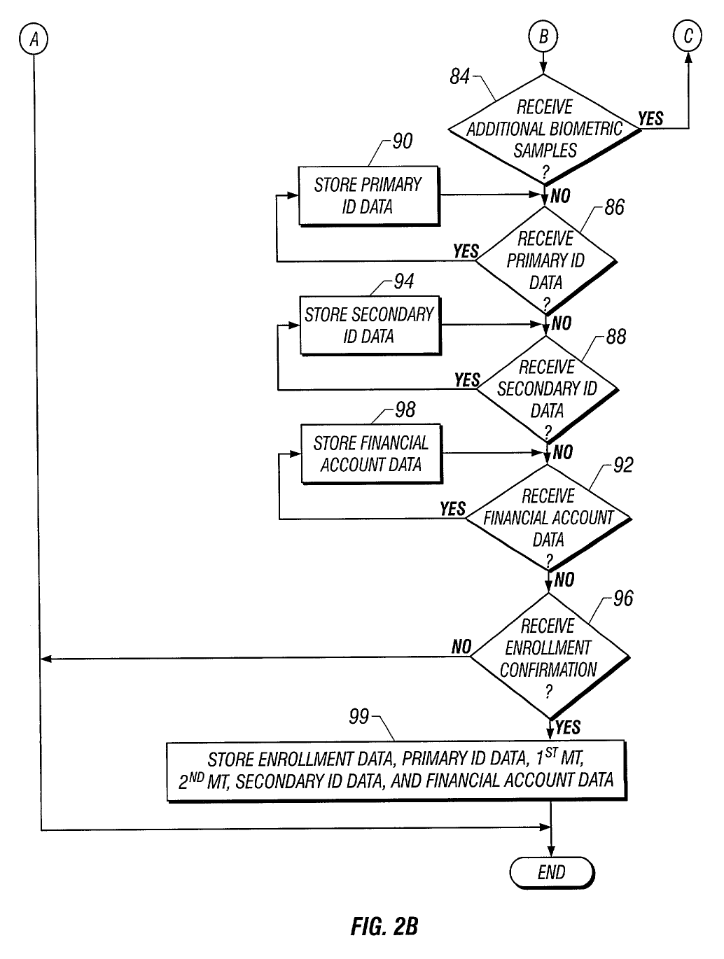

Referring now to FIG. 2, a preferred method for enrolling applicants in the present system begins in step 50, wherefrom control passes to step 52 if the system receives an enrollment request; otherwise, the present method terminates from step 50 to await an enrollment request. From step 52, control passes to step 54 if the system receives enrollment data; otherwise, control passes from step 52 to step 56, wherefrom control returns to step 52 if a maximum number of attempts of receiving enrollment data has not been exceeded; otherwise, the present method terminates from step 56 to await enrollment data. In step 54, the system stores received enrollment data. Enrollment data comprises, for example, the applicant's name, address, phone number, and other related information. Applicants preferably input enrollment data from the points-of-sale 12 or remote computer 40 of FIG. 1, wherefrom it is received by the CS 28. Alternatively, the applicant may also use one or more enrollment kiosks (not shown) connected to the CS 28 through the LAN 36 to enter enrollment data. Applicants may enter enrollment data contemporaneously with other acts of enrollment, or in advance of actual enrollment at one of the points-of-sale 12. Until an applicant completes enrollment, the system preferably stores the enrollment data within volatile memory of the CS 28, such as the internal memory device 32. The system can, of course, also store the enrollment data within non-volatile fixed storage device 34, as would be the case, for example, if the applicant entered enrollment data from the remote computer 40. Regardless, after the system receives enrollment data in step 52, it stores the data in step 54, wherefrom control passes to step 58.

From step 58, control passes to step 60 if the system receives primary identification data; otherwise, control passes from step 58 to step 62, wherefrom control returns to step 58 if a maximum number of attempts of receiving primary identification data has not been exceeded; otherwise, the present method terminates from step 62 to await primary identification data. In step 60, the system stores received primary identification data. Primary identification data comprises, for example, data from a primary identification source, such as a driver's license number from a driver's license; a social security number from a social security card; a military identification number from a military identification card; or a state identification number from a state identification card. While primary identification sources include, but are not limited to, driver's licenses, social security cards, military identification cards, and state identification cards, they generally include sources of identification that are issued from an external third party and contain reasonable assurances of identity. Primary identification sources must be reasonably unique to the applicant because they provide gateway access into the systems described herein. Hence, they oftentimes comprise photographic identification cards from recognized governmental sources. In addition, the system may not store the applicant's primary identification data in step 60, for example, if another applicant used the same primary identification data to enroll in the system, or if the system does not otherwise recognize the data as originating from an acceptable and unique primary identification source.

Unlike enrollment data, the system preferably receives primary identification data under the supervision of a trusted person, such as a store employee for example, charged with enrollment supervision. In such an embodiment, the system receives primary identification data at specified points-of-sale 12 of FIG. 1 or other various enrollment centers (not shown) such as a customer service counter or kiosk within the transactional environment 10. In such an embodiment, the trusted person verifies the system's receipt of proper primary identification data; for example, in a preferred embodiment, the person personally inspects the applicant's primary identification source. Like enrollment data, primary identification data can also be temporarily stored within volatile memory of the CS 28 while the applicant completes the enrollment process, or stored immediately within the non-volatile fixed storage device 34.

After the system stores the primary identification data in step 60, control passes therefrom to step 64. In step 64, the system receives a first image of a biometric sample from an applicant enrolling in the system. For example, if the biometric scanner 26 in FIG. 1 is configured to receive fingerprint images as described above, the preferred receiving or processing apparatus has reflective properties that change as a function of skin contact with the platen. Changes in intensity—corresponding to the surface of the presented biometric—are then modulated into a digital fingerprint image that the system receives at this step. As will be elaborated upon shortly, the first image that the system receives in step 64 is not, for the purposes of this description, referred to as a “live image” because there is presently no other images with which it is to be compared, as that term is used hereinout.

From step 64, control passes to step 66, wherein the system creates a first master template from the first image of the biometric sample received in step 64. A “master template” is a template against which the system compares a live template. A “live template” is a template created by the system from a live image presented by an applicant. A “live image” is any image presented after the first master template is created. The system compares live templates to one or more master templates to produce either a successful or failed correspondence according to predefined criteria. Generally speaking, a “template” is an electronic record, file, file-set, or the like, of one or more prioritized features or characteristics that represent a biocharacteristic. The system extracts the features or characteristics from the received image. In a preferred fingerprint image embodiment, for example, representative features include, but are not limited to, endpoints, bifurcations, and islands. Likewise, representative characteristics include, but are not limited to, ridge length data, core data, and feature data. Because templates are more compact than the image of the biocharacteristics they represent, they are more easily stored, transmitted, and compared by the system. In addition, templates often contain more than just the electronic version of the digitized image; they may also contain other information about the biocharacteristic as well. In any event, after the system generates the first master template in step 66, control then passes therefrom to step 68, wherein the system stores the first master template, as previously described.

From step 68, control passes to step 70, wherein the system receives a second image of the biometric sample presented by the applicant enrolling in the system. The second image is referred to as a “live image” because a template generated therefrom can be compared against a master template—namely, the first master template generated in step 66. Preferably, the live image is of the same biometric sample from the same applicant as the first image. If the live image is of a different biometric sample than the first image, the live image will not correspond to the first image in a subsequent matching step 74, as elaborated upon below. In any event, control passes from step 70 to step 72, wherein the system creates a live template from the live image, just as it created the first master template from the first image.

After the system generates the live template in step 72, control passes therefrom to step 74, wherein the system compares the live template to the first master template. If the live template corresponds to the first master template according to predefined criteria—such as a correlation score or other threshold, as understood in the art—control then passes to step 76, wherein the system creates a second master template from the live image; otherwise, control passes from step 74 to step 78, wherefrom control returns to step 70 if a maximum number of attempts of receiving the live image has not been exceeded; otherwise, control passes from step 78 to step 80, wherefrom control returns to step 64 if a maximum number of attempts of receiving the first image has not been received; otherwise, the present method terminates from step 80 to await a first image and live image from which a respective first master template and live template correspond during the generally one-time enrollment process, from which the second master template is created from the live image.

In any event, control next passes from step 76 to step 82, wherein the system stores the created second master template, as previously described. In an alternative embodiment, if the system is unable to identify a first image or a live image, or to otherwise generate the first or second master template from the respective first or live image, or to otherwise correspond the live template to the first master template, the system may still store the respective templates as a “void-image,” which otherwise allows the applicant to continue enrolling in the system, albeit with limited biometric data. The system does not reject the applicant's enrollment because of a void-image, but otherwise allows the applicant to proceed with the data received.

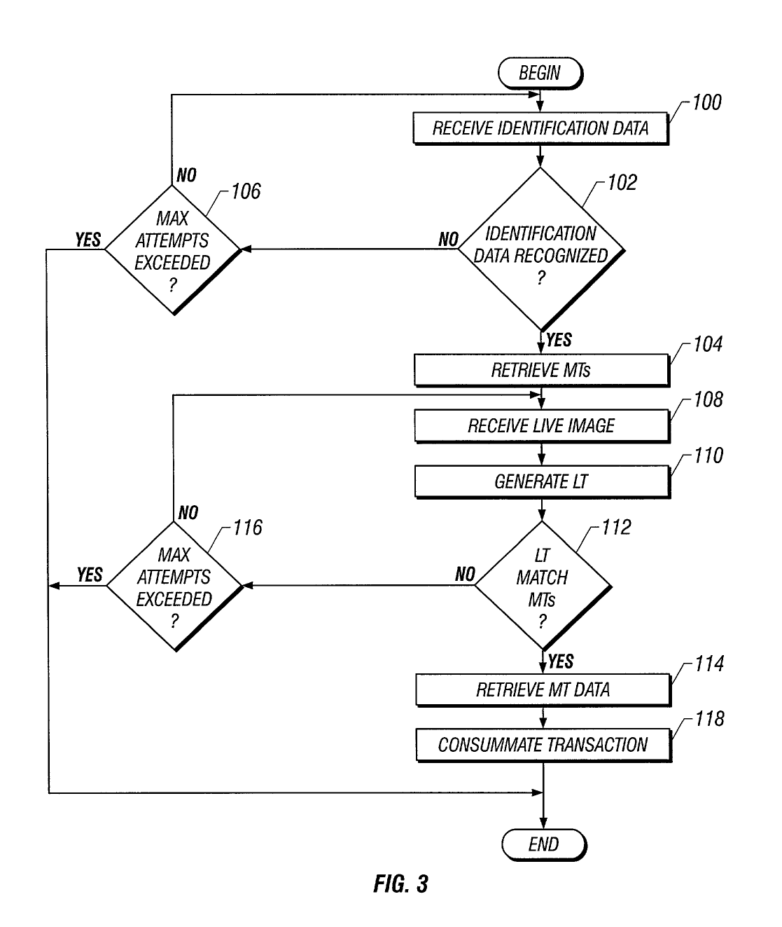

After step 82, the system now has, in the preferred embodiment, two master templates with which all subsequent live templates will be compared in each subsequent access attempt, as elaborated upon in conjunction with FIGS. 3-5. If an applicant's live template fails to correspond to the first or second master template according to the predefined criteria, the system rejects the applicant as a non-enrolled user of the system, and access is denied.

By this illustrative embodiment, the first and second master templates are separate templates. In other words, the system does not compare the multiple master templates at enrollment for the purpose of storing only one thereof. Rather, the present invention increases biometric matching versatility by storing two or more master templates for each biometric sample received. While a preferred embodiment generates and stores two master templates for each biometric sample received, the invention is not limited in this regard. Rather, the system can also generate and store three or more master templates for each biometric sample.

The system compares subsequent live templates against the multiple master templates created at enrollment. Because the system uses the images received in step 64 and 70 to create referent master templates, it is preferred that these steps be under the supervision of the trusted person, such as the store employee for example, charged with enrollment supervision, as previously elaborated upon. In such an embodiment, the trusted person verifies the system's proper receipt of the first image and live image; for example, in a preferred embodiment, the person personally assists the applicant with proper placement of the biometric sample within the biometric scanner 26.

After the system stores the second master template in step 82, control then passes therefrom to step 84. From step 84, control passes to step 86 if the system receives no additional biometric samples; otherwise, control passes from step 84 to step 64 if the system receives additional biometric samples. In this fashion, steps 64-82 are iterative in nature in that any specified number of biometric samples may be received. While a preferred embodiment of the present invention receives two biometric samples from each applicant (i.e., left and right index fingers in a fingerprint embodiment)—and generates and stores two or more master templates for each—the invention is not limited in this regard. For instance, the system can receive one, two, three, or more biometric samples for each applicant. Thus, the preferred embodiment of the present system generates multiple master templates for each biometric sample, regardless of the number of biometric samples the system receives.

After step 84, the applicant has completed enrollment in the system. The applicant's enrollment data, primary identification data, and master templates have been stored for each biometric sample. From step 86, control then passes to step 88 if the system does not receive additional primary identification data; otherwise, control passes from step 86 to step 90 wherein the system stores additionally received primary identification data, if any, as previously described. While the system previously received primary identification data from one primary identification source for each applicant in steps 58-62, the system may also receive additional primary identification data from additional primary identification sources at this step. The more primary identification data that the system receives for an applicant, the more ways the applicant will later have to access the system.

From step 88, control passes to step 92 if the system does not receive secondary identification data; otherwise, control passes from step 88 to step 94, wherein the system stores additionally received secondary identification data, if any, as previously described. Although the system need not receive secondary identification data to complete enrollment, the more secondary identification data that the system receives for an applicant, the more ways the applicant will later have to access the system. Thus, the system receives additional secondary identification data, if any, in step 88, and it preferably receives it from the other periphery 18, the alphanumeric data input device 20, or the binary or other coded data input device 22.

Secondary identification data comprises data from an applicant's secondary identification sources, including, but not limited to, for example, a loyalty number from a loyalty card, a birthday, anniversary date, telephone number, or any other personal identification number (“PIN”) or personal identification code (“PIC”) chosen by an applicant. Secondary identification data thus comprises data from sources that generally could not have been used as primary identification sources, and it has no intrinsic value to the present system. Rather, the system does not, in the preferred embodiment, use secondary identification data for dispositive identification purposes, but only as a pointer into the fixed storage device 34 to retrieve master templates associated therewith. Thus, unlike primary identification data, it is not required that secondary identification data be unique to a single individual, and it may or may not contain unique and reasonable assurances of identity. In fact, multiple users may enter and use the same secondary identification data, as the system uses the secondary identification data to identify a subset of the master templates and data stored within the fixed storage device 34. Thus, in the preferred embodiment, the system generally stores secondary identification data without regard to previously stored secondary identification data.

As a representative example, a commonly shared birthday may be received as a secondary source of identification from multiple applicants sharing that birthday. In the preferred embodiment, the system does not use secondary identification data, or any identification data, as a password or password equivalent in conjunction with authenticating a live image. Instead, the preferred system uses it to identify a subset of associated master templates with which it compares live templates. Thus, the system may receive a common birthday, for example, as secondary identification data. In any event, control passes from step 88 to step 92 if the system does not receive additional secondary identification data.

From step 92, control passes to step 96 if the system does not receive financial account data; otherwise, control passes from step 92 to step 98, wherein the system stores additionally received financial account data, if any, as previously described. Although the system need not receive financial account data to complete enrollment, the more financial account data that the system receives for an applicant, the more ways the applicant will later have to initiate access to the system. Moreover, financial account data, if received, permits the applicant to consummate financial transactions, as primary and secondary identification data generally do not permit the applicant to consummate transactions. Thus, the system receives additional financial account data, if any, in step 92, and it preferably receives it from the other periphery 18, the alphanumeric data input device 20, or the binary or other coded data input device 22.

Financial account data comprises data from an applicant's financial accounts, including, but not limited to, for example, data such as financial account numbers and expiration dates from credit cards, debit cards, electronic benefits transfer (“EBT”) cards, electronic finds transfer (“EFT”) data, checking account and bank routing numbers, etc. Financial account data thus comprises data that generally could not have been used as primary or secondary identification sources, and it has no intrinsic value to the present system. Rather, the preferred system does not use financial account data for dispositive identification purposes, but initially as a pointer into the fixed storage device 34 to retrieve master templates associated therewith, and then later to consummate the user's financial account transactions. Like secondary identification data, it is not required that financial account data be unique to a single individual, and it may or may not contain unique and reasonable assurances of identity. In fact, multiple users may enter and use the same financial account data, as the system uses financial account data initially to identify a subset of the master templates and data stored within the fixed storage device 34, and then to consummate financial transactions. Thus, in the preferred embodiment, the system generally stores financial account data without regard to previously stored financial account data.

As a representative example, a jointly owned checking account may be received as financial account data from applicants sharing a joint checking account. The preferred system does not use financial account data, or any identification data, as a password or password equivalent in conjunction with authenticating a live image. Instead, the system uses it initially to identify a subset of associated master templates with which it compares live templates, and then to consummate transactions. Thus, the system may receive a common credit card account, for example, as financial account data. Incidentally, if the present system consummates transactions other than financial transactions, other types of data—such as access data in a system controlling access to a particular building, structure, parking garage, or part thereof—are received and stored in steps 92 and 98. For illustrative and clarity purposes, however, financial account data is generally referred to hereinout. In any event, control passes from step 92 to step 96 if the system does not receive additional financial account data.

From step 96, control passes to step 99 if the system receives enrollment confirmation; otherwise, the method terminates from step 96 to await enrollment confirmation, as enrollment may, of course, be cancelled at any other time as well. In step 99—regardless of where the system stored the enrollment data, primary identification data, secondary identification data, if any, and financial account data, if any, heretofore—the system now stores, in a preferred embodiment, this data in the non-volatile fixed storage device 34. In addition, the system preferably stores, as understood in the art, the applicant's enrollment data, primary identification data, secondary identification data, and financial account data in relation to an internal identification index that is independent thereof. The preferred system does not relate the index to a specific element of enrollment data or identification data, as the index preferably exists apart therefrom. It thus exists outside of the data itself whereby if the data expires or otherwise changes, the system still identifies applicants by the index.

Referring now to FIG. 3, a preferred method for an applicant to access the present system begins in step 100, wherein the system receives unrestricted “identification data.” As used throughout this description, identification data generally encompasses and refers to all of the primary identification data, secondary identification data, and financial account data that the system receives from the applicant. Because applicants may present any of these sources of identification data to access the system, the identification data received is unrestricted.

The system can receive identification data from an applicant by any of the following: receiving a swiped data card containing such data from the binary or other coded data input device 22 of the biometric scanning device 16 of FIG. 1; receiving a data card containing such data from a bar scan through the binary or other coded data input device 22; receiving data from a check or other financial instrument passing through the other periphery 18 such as the MICR; receiving data from keyed input from the alphanumeric data input device 20; or otherwise. Thus, even if an applicant is without a physical token such as a data card, the applicant can use any enrolled identification data to initiate system access. For example, an applicant can consummate a credit card or check transaction by presenting the applicant's phone number if the system previously stored the phone number as part of the applicant's secondary identification data and the credit card or check data as part of the applicant's financial account data. Any of the enrolled primary identification data, secondary identification data, or financial account data can be used to initiate access to the system in step 100 as received identification data. Thus, the received identification data received is unrestricted. It may be received from token means, non-token means, or otherwise.

From step 100, control passes to step 102, wherefrom control passes to step 104 if the system recognizes the received identification data; otherwise, control passes from step 102 to step 106, wherefrom control returns to step 100 if a maximum number of attempts of receiving and recognizing the identification data has not been exceeded; otherwise, the present method terminates from step 106 to await receiving and recognizing identification data. In a preferred embodiment of step 104, the system retrieves all of the master templates from the fixed storage device 34 associated with the recognized identification data. For example, if the identification data comprises primary identification data such as the applicant's driver's license, the system retrieves all master templates associated with the received driver's license identification data. If, on the other hand, the identification data comprises secondary identification data such as the applicant's birthday, the system retrieves all master templates associated with the received birthday identification data. Thus, the retrieved master templates may or may not be unique to that applicant. Alternatively, if the identification data comprises financial account data such as the applicant's credit card number, the system retrieves all master templates associated with the received financial account data. Thus, the retrieved master templates may or may not be unique to that applicant. In any event, the system retrieves a smaller subset of all the master templates stored in the fixed storage device 34, and preferably retrieves them into the internal memory device 32 of the CS 28 of FIG. 1.

As explained, the system receives identification data before it receives a live image of a biometric sample from an applicant attempting to access the system. Then, it retrieves all of the master templates associated with the unrestricted identification data. Thus, the identification data generates a subset of all the master templates at the time the applicant attempts to access the system. It creates a dynamic pointer into the fixed storage device 34, whereby the subsets are dynamically created—not at enrollment—but at run-time.

From step 104, control passes to step 108, wherein the system receives a live image of a biometric sample from an applicant attempting to access the system. The live image is preferably received from the biometric scanner 26 in FIG. 1, as in step 70 of the enrollment process of FIG. 2. Next, control then passes from step 108 to step 110, wherein the system generates a live template from the live image, as in step 72 of the enrollment process of FIG. 2. Then, control passes from step 110 to step 112, wherefrom control passes to step 114 if the live template corresponds to one of the master templates retrieved in step 104 according to predefined criteria; otherwise, control passes from step 112 to step 116, wherefrom control returns to step 108 if a maximum number of attempts of receiving the live image has not been exceeded; otherwise, the present method terminates from step 116 to await identification data and a live image from which a live template corresponds to one of the retrieved master templates associated with the unrestricted identification data.

The system does not recognize the applicant unless the live template corresponds to at least one of the retrieved master templates associated with the unrestricted identification data. Thus, the system denies the applicant's access to the system if the live template fails to correspond to at least one of the retrieved master templates associated with the identification data. In any event, step 112 in FIG. 3 is analogous to step 74 in FIG. 2.

In a preferred embodiment of step 114, the system retrieves additional data associated with the corresponding master template. This additional data is preferably retrieved from the fixed storage device 34, and while it could also have been retrieved in step 104 with the retrieval of the subset of master templates, it is preferred that the system retrieve this additional data only after the live template has corresponded to a particular master template. For example, the additional data may comprise financial account data, if any, in an embodiment supporting consummating financial account transactions. Other additional data, including elements of the enrollment data or other elements of the identification data may also be retrieved in step 114. For example, if the system stored additional data, such as the applicant's loyalty preferences or other, such additional data can be retrieved after biometrically identifying the applicant. While receiving and storing such additional data to the system is not shown in FIG. 2, the system preferably proceeds to do so in a fashion analogous to steps 86-98 in that figure.

As understood in the art, the system may also present some of the additional data to the applicant on the textual and graphic output device, such as, for example, a welcome message identifying the applicant by name or loyalty account number. The system knows the identity of the applicant by step 114, as the applicant's corresponding master template is linked to the applicant's primary identification data received at enrollment, which uniquely pinpoints the specific applicant. Indeed, the system can also ascertain the applicant's entire transactional history, including the applicant's financial account data and history.

From step 114, control passes to step 118, wherein the system consummates a transaction. For example, in a biometric verification system relating to accessing a building, structure, parking garage, or part thereof, consummating the transaction in step 118 corresponds to the system granting access to the applicant.

Alternatively, in a system relating to consummating financial transactions, step 118 corresponds to allowing the financial transaction to proceed, in accordance, at least in part, with the additionally retrieved data in step 114. For example, the financial transaction may be consummated with the financial account data stored in step 98 of FIG. 2. In one embodiment, the transaction may be consummated with financial account data stored as identification data. Thus, if the applicant presented an enrolled credit card as identification data, the financial transaction can be consummated using financial account data associated with that credit card. In a preferred embodiment, the applicant need not re-present the credit card to consummate the transaction, as presenting it as identification data suffices for presenting it as financial account data as well. In another preferred embodiment, the financial account data can also be updated, if necessary. For example, if the applicant presents the credit card as identification data, and the credit card has a new expiration date since the applicant enrolled in the system or last used the card within the system, the applicant's financial account data can be automatically updated to reflect the new expiration date. In another preferred embodiment, consummating the transaction comprises receiving authorization for consummating the transaction from either the applicant or an external third party such as the ACH. Preferably, this authorization precedes consummation. In an embodiment wherein the system receives authorization from an external party, the authorization may be based on a data exchange with the third party, such as the third party granting authorization based on its own databases and records.

If an applicant has enrolled multiple financial accounts as financial account data, the financial account data can be presented to the applicant on the textual and graphic output device 24 of FIG. 1 for selection therebetween. For example, if the applicant enters an enrolled phone number as identification data, the applicant's related financial account data can be presented to the applicant, who can make a selection therebetween. Thus, the applicant can elect a particular credit card or checking account for consummation even if the physical credit card or check is not presented at the time of consummation. The applicant need not sign a credit card slip or fill out a check if the applicant's financial account data comprises such information. The applicant's biometric identification—as related to the applicant's associated primary identification data—is more reliable than the applicant's signature, given the oftentimes cursory inspection provided by the receiving agent thereof. Thus, consummation is paperless, and thereby hastened, increasing throughput at the points-of-sale 12. Thus, the system can consummate the applicant's financial transaction based on receipt of selection from financial account data presented to the applicant. Alternatively, consummation can be split among multiple sources comprising the applicant's financial account data, and may require accessing one or more of the third party servers 38 of FIG. 1, such as the ACH.

Consummation can also refer to other transactional activities as well. For example, if the applicant enrolled a loyalty data card as secondary identification data, consummation can automatically trigger loyalty card activity as well, such as recording the transaction for special discounts, promotions, or other. The applicant is thus unburdened from having to present the loyalty data card at the time of consummation, as such secondary identification data is tied to the applicant even if not presented as identification data, and automatically launched when the applicant consummates the transaction in step 118. For example, the system can automatically update the applicant's account data if the applicant is participating in a frequent buyer program that the applicant enrolled in the system.

Of course, the applicant can also consummate a transaction in step 118 without recourse to the stored financial account data. For example, the applicant can consummate a financial transaction with a cash payment or a non-enrolled data card. If a non-enrolled credit card is used to consummate a financial transaction, a preferred embodiment of the system stores data from the non-enrolled data card. In one embodiment, the data from the non-enrolled data card is added to the applicant's financial account data, whereby the presented data card is thereby enrolled in the system, and becomes not only a part of the applicant's subsequent financial account data, but also a part of the applicant's subsequent identification data, whereby the applicant can later use that data card to initiate access to the system and consummate transactions therewith. In an alternative embodiment, the system can also store data from the non-enrolled data card as part of tracking data, whereby the system can identify patterns of fraudulent transactional activity. In this way, the system monitors even non-enrolled transactional activity.

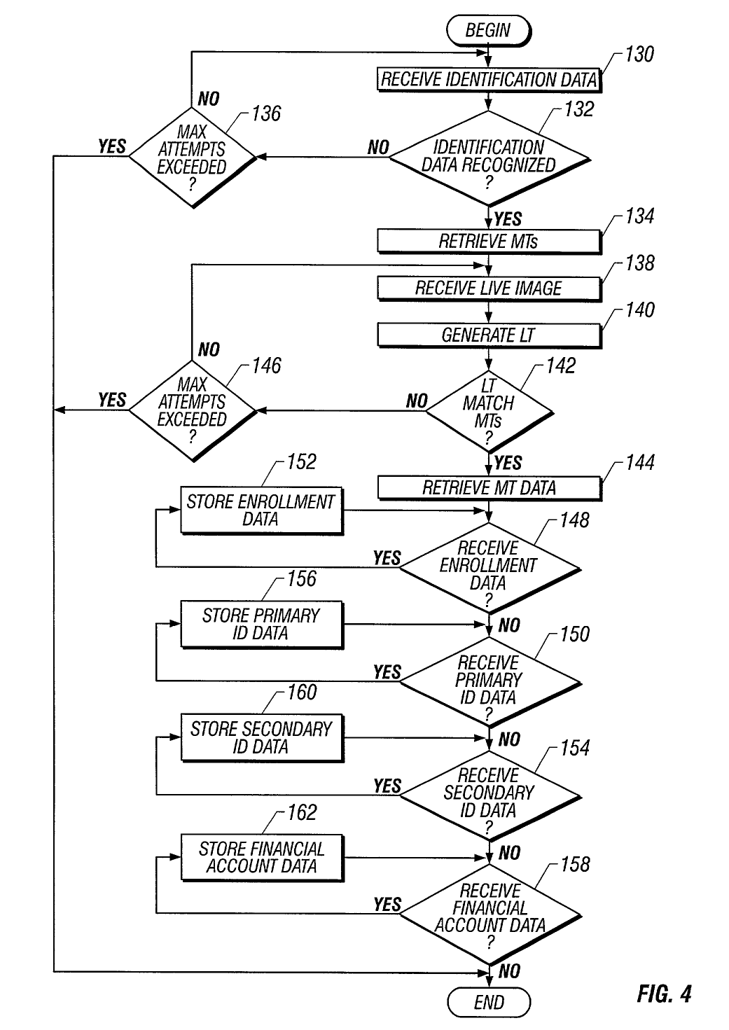

As described, accessing the biometric verification system of the present invention may comprise consummating a transaction, such as either a financial transaction or non-financial transaction. It may also comprise, for example, receiving and storing additional enrollment data from the applicant if the applicant has changed addresses or phone numbers and seeks to update that data within the system. Likewise, it may also comprise, for example, receiving and storing additional identification data, including primary identification data, secondary identification data, and financial account data, if the applicant seeks to update that data within the system. Such account maintenance activities are depicted in FIG. 4. More specifically, the method begins in step 130, wherein control passes from steps 130-146 as it passed from steps 100-116 of FIG. 3, by which the system receives identification data from an applicant and biometrically identifies the applicant based thereon. However, control passes from step 144 to step 148 in FIG. 4. Control then passes from step 148 to step 150 if the system does not receive additional enrollment data; otherwise, control passes from step 148 to step 152 to store additional received enrollment data, as previously discussed, and then back to step 148.

From step 150, control then passes to step 154 if the system does not receive additional primary identification data; otherwise, control passes from step 150 to step 156 to store additionally received primary identification data, as previously discussed, and then back to step 150. From step 154, control passes to step 158 if the system does not receive additional secondary identification data; otherwise, control passes from step 154 to step 160 to store additionally received secondary identification data, as previously discussed, and then back to step 154. The method then terminates after 158 if the system does not receive additional financial account data; otherwise, control passes from step 158 to step 162 to store additionally received financial account data, as previously discussed, and then back to step 158. With control passing through these loops, it can store additional enrollment data, primary identification data, secondary identification data, and financial account data, as desired. The system can store the modified data, if any, in the fixed storage device 34 of FIG. 1. Alternatively, the system can require receiving a specified type of identification data to modify consummate transactions. For example, the system may require receiving primary identification data to change enrollment data such as an applicant's address, although the system is not limited in this regard.

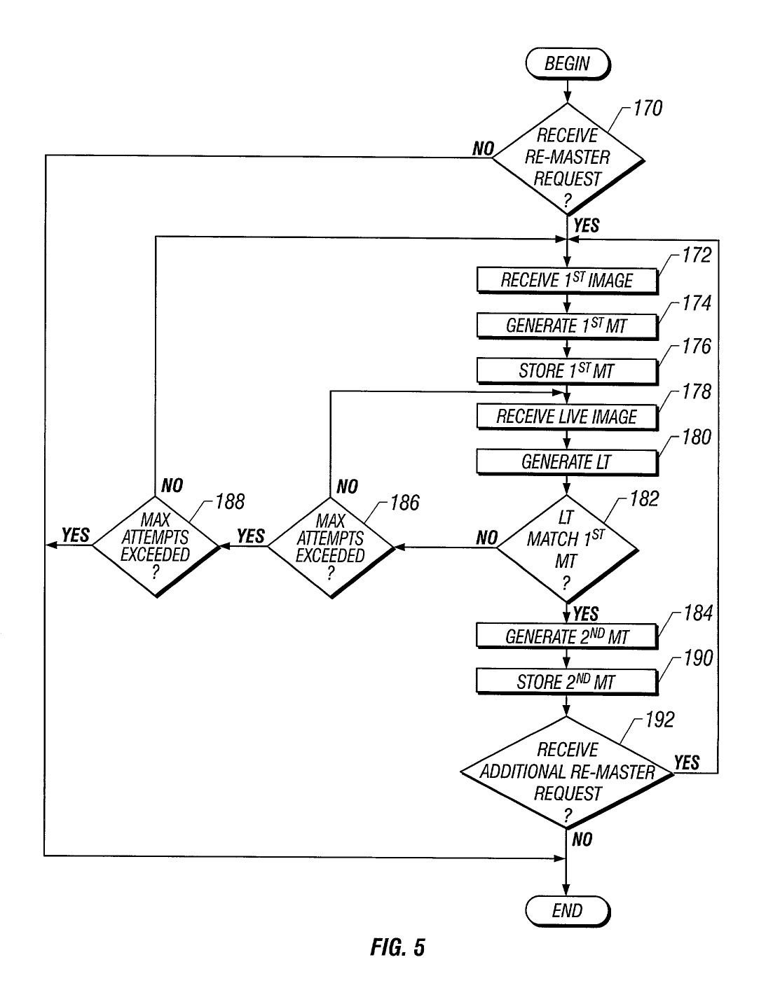

In addition to modifying enrollment and identification data as in FIG. 4, applicants can also re-create their master templates by a preferred method illustrated in FIG. 5. More specifically, the method begins in step 170, wherein the system receives a request to re-master an applicant's master templates; otherwise, the method terminates from step 170 to await a re-master request. Because the system re-creates master templates in a re-master request, it is preferred that these steps be under the supervision of the trusted person, such as the store employee for example, charged with enrollment supervision, as previously described. In such an embodiment, the trusted person verifies the system's receipt of proper primary identification data; for example, in a preferred embodiment, the person personally inspects the applicant's primary identification source. In such an embodiment, it is generally unnecessary for the system to biometrically identify the applicant prior to executing a re-master request; presumably, the system's inability to biometrically identify the applicant is why the system received this request to re-master, although the invention is not limited in this regard. In addition, the trusted person can verify the system's proper receipt of the first image and live image; for example, in a preferred embodiment, the person personally assists the applicant with proper placement of the biometric sample within the biometric scanner 26. In any event, control passes from step 170 to steps 172-190, as it passed from steps 64-82 of FIG. 2, by which the system creates new master templates and stores them in the fixed storage device 34 in place of the old master templates. However, control passes from step 190-192 in FIG. 5. Control then passes from step 192 to step 172 if the system receives another request to re-master another biometric sample; otherwise, the present method terminates from step 192 to await another request.

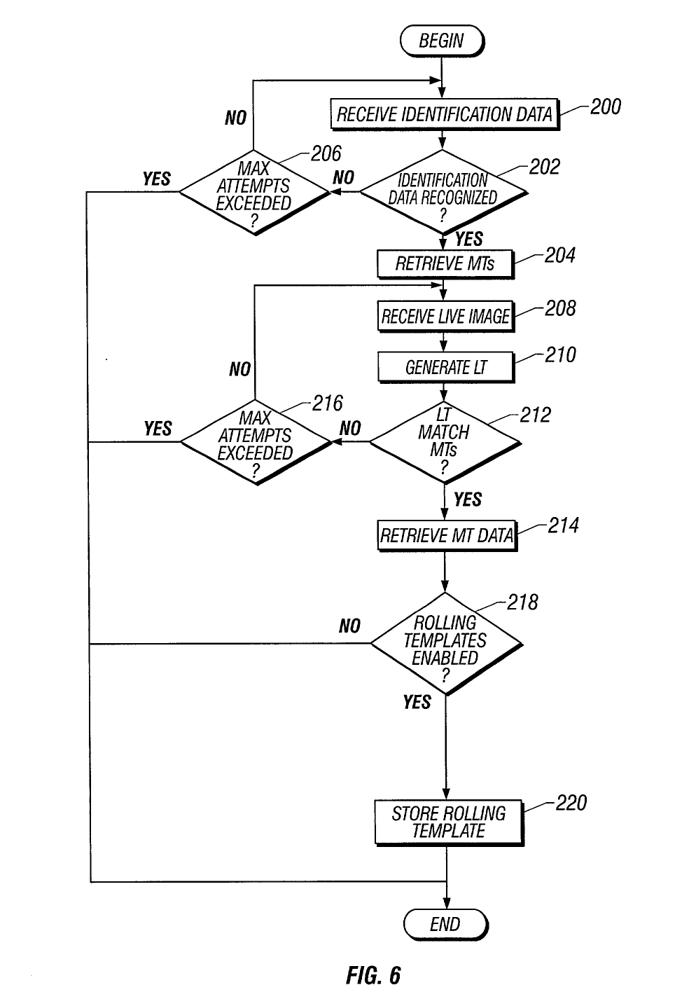

FIG. 6 presents a preferred method for accommodating the dynamic nature of biometric samples in the present biometric verification system. Referring generally, it enables the present system to store rolling templates for comparison with subsequent live templates created from subsequent live images. For the purposes of this description, a “rolling template” is a template created from a live image against which the system compares a live template. In this sense, it is like a master template, and may be stored as such.

More specifically, the method begins in step 200, wherein control passes from steps 200-216 as it passed from steps 100-116 of FIG. 3, by which the system receives identification data from an applicant and attempts to biometrically identify the applicant. However, control passes from step 214 to step 218 in FIG. 6, wherefrom passes to step 220 if rolling templates are enabled; otherwise, the present method terminates from step 218 to await rolling template enablement. In step 220, the system stores the live image as a rolling template, preferably until the system has stored a predetermined number of rolling templates. If the system has already stored a maximum number of rolling templates for this applicant, the rolling templates are preferably sorted and stored according to predefined criteria, whereby, for example, the system stores templates having the most readily identified or prominent features or characteristics that represent the biocharacteristic.

Depending on quality or other factors, a first rolling template may or may not replace a second rolling template. For example, if a second rolling template is characterized by eight prioritized features or characters whereas a first rolling template only identified six, the system preferably replaces the first rolling template with the second rolling template since the second rolling template may be more useful for comparison against subsequent live templates generated from subsequent live images. Similarly, if the second rolling template is characterized by eight prioritized features or characters whereas a first or second or other master template only identified six, the system preferably replaces the respective master template with the second rolling template since the second rolling template may be more useful for comparison against subsequent live templates generated from subsequent live images. In this way, the second rolling template becomes a master template within the system. In any event, original master templates are preferably given preferential treatment over rolling templates converted into master templates because the original master templates were, in a preferred embodiment, generated from live images which were received by the system under the supervision of a trusted person, such as a store employee for example, charged with enrollment supervision. In any event, from step 220, the present method terminates.

As described, the present method increases the system's chances of corresponding a live template, and thus decreases the chances of getting a false rejection. It is compatible with any system that stores a combination of robust identification data and multiple master templates for each biometric sample for the applicant, as previously discussed. For example, the applicant's identification data is otherwise unaffected by storing the rolling templates.

The spirit and scope of the present invention is not limited to any of the various embodiments described above. Rather, the details and features of exemplary and preferred embodiments have been disclosed. Without departing from the spirit and scope of this invention, other modifications will therefore be apparent to those skilled in the art. Thus, it must be understood that the detailed description of the invention and drawings were intended as illustrative only, and not by way of limitation.

What is claimed is:

1. A method for mitigating distortive effects in an applicant's biometric sample in a biometric verification system that stores a master template for each biometric sample for said applicant, said method comprising steps of:
a. receiving a live image of a biometric sample from said applicant;
b. generating a live template from said live image;
c. generating a rolling template from said live image if said live template corresponds to said master template according to predefined criteria; and
d. storing said rolling template;
wherein said system allows said applicant to access said system if a subsequent live template generated from a subsequent live image of said biometric sample from said applicant corresponds to at least one of said master or rolling templates for said applicant according to predefined criteria.

2. The method of claim 1 wherein said system stores said rolling template as a master template.

3. The method of claim 1 wherein said system stores a predetermined number of said rolling templates.

4. The method of claim 3 wherein said system stores said rolling templates sorted according to predefined criteria.

5. The method of claim 1 wherein said system stores enrollment data and identification data comprising primary identification data, secondary identification data, if any, and financial account data, if any, for said applicant.

6. The method of claim 1 wherein said system stores multiple master templates for each biometric sample for said applicant.

7. The method of claim 1 wherein said system stores enrollment data and identification data comprising primary identification data, secondary identification data, if any, financial account data, if any, and multiple master templates for each biometric sample for said applicant.

8. The method of claim 1 wherein said biometric sample comprises a fingerprint.

9. The method of claim 1 wherein said biometric sample comprises a voiceprint.

10. The method of claim 1 wherein said biometric sample comprises a handprint.

11. The method of claim 1 wherein said biometric sample comprises hand writing.

12. The method of claim 1 wherein said biometric sample comprises hand geometry.

13. The method of claim 1 wherein said biometric sample comprises facial geometry.

14. The method of claim 1 wherein said biometric sample comprises facial recognition.

15. The method of claim 1 wherein said biometric sample comprises a retinal scan.

16. The method of claim 1 wherein said biometric sample comprises an iris scan.

17. The method of claim 1 wherein said biometric sample comprises thermal imaging.

18. A computer-readable storage medium comprising computer executable code for mitigating distortive effects in an applicant's biometric sample in a biometric verification system that stores a master template for each biometric sample for said applicant, said code instructing a computer to operate as follows:
a. receive a live image of a biometric sample from said applicant;
b. generate a live template from said live image;
c. generate a rolling template from said live image if said live template corresponds to said master template according to predefined criteria; and
d. store said rolling template;
wherein said system allows said applicant to access said system if a subsequent live template generated from a subsequent live image of said biometric sample from said applicant corresponds to at least one of said master or rolling templates for said applicant according to predefined criteria.

19. The system of claim 18 wherein said system stores said rolling template as a master template.

20. The system of claim 18 wherein said system stores a predetermined number of said rolling templates.

21. The system of claim 20 wherein said system stores said rolling templates sorted according to predefined criteria.

22. The system of claim 18 wherein said system stores enrollment data and identification data comprising primary identification data, secondary identification data, if any, and financial account data, if any, for said applicant.

23. The system of claim 18 wherein said system stores multiple master templates for each biometric sample for said applicant.

24. The system of claim 18 wherein said system stores enrollment data and identification data comprising primary identification data, secondary identification data, if any, financial account data, if any, and multiple master templates for each biometric sample for said applicant.

25. The system of claim 18 wherein said biometric sample comprises a fingerprint.

26. The system of claim 18 wherein said biometric sample comprises a voiceprint.

27. The system of claim 18 wherein said biometric sample comprises a handprint.

28. The system of claim 18 wherein said biometric sample comprises hand writing.

29. The system of claim 18 wherein said biometric sample comprises hand geometry.

30. The system of claim 18 wherein said biometric sample comprises facial geometry.

31. The system of claim 18 wherein said biometric sample comprises facial recognition.

32. The system of claim 18 wherein said biometric sample comprises a retinal scan.

33. The system of claim 18 wherein said biometric sample comprises an iris scan.

34. The system of claim 18 wherein said biometric sample comprises thermal imaging.
